(19) United States
(12) Patent Application Publication
(10) Pub. No.: US 2017/0068237 A1
(43) Pub. Date: Mar. 9, 2017

(54) DEVICE CONTROL SYSTEM

(71) Applicant: MINEBEA CO., LTD., KITASAKU-GUN (JP)

(72) Inventors: NAOKI YAMAGUCHI, FUKUROI-SHI (JP); KOHEI NISHIBORI, IWATA-SHI (JP)

(21) Appl. No.: 15/251,862

(22) Filed: Aug. 30, 2016

(30) Foreign Application Priority Data
Sep. 4, 2015 (JP) 2015-174898

(51) Int. Cl. G05B 19/402; G05B 19/042

(52) U.S. Cl. CPC G05B 19/402; G05B 19/0426; H04W 84/18

(57) ABSTRACT

A device control system includes: a plurality of devices each of which having at least one controllable part; and a controller including a processor and a memory storing computer-readable instructions that, when executed by the processor, causing the controller to perform: calculating positions, in which the plurality of devices are in a desired state, based on positional coordinates, at which the plurality of devices are installed, based on a one spatial coordinate; and generating a control signal for controlling the controllable part based on the calculated target positions, wherein the plurality of devices transitions the controllable part to the desired state according to the control signal.

### BACKGROUND OF THE DISCLOSURE

1. Field of the Invention

The present invention relates to a device control system including a device having a drivable part and a remote controller that remotely operates the device.

2. Description of the Related Art

In the related art, the state of illumination is changed according to usage or performance contents on a stage in a theater, and a plurality of spotlights are used for such purposes. The spotlight has a plurality of functions such as panning, tilting, zooming, dimming, lighting, and extinction.

In order to easily change the state of the illumination, there has been disclosed a system that changes the lighting directions of the plurality of spotlights by using a remote controller. An example of such system is disclosed in JP-A-H07(1995)-312296.

JP-A-H07(1995)-312296 discloses a remote control spotlight system including a plurality of spotlights, a lighting direction changing device provided with a driving unit for driving the spotlights and individually changing the lighting directions of the spotlights, and a control device that gives a command for changing the lighting directions to the lighting direction changing device, wherein the control device includes a transmitting part for transmitting the command for changing the lighting directions as a wireless signal, and the lighting direction changing device includes a receiving unit for receiving the wireless signal, a direction determining unit for determining the transmission direction of the wireless signal based on the wireless signal received in the receiving unit, and a control unit for controlling the driving unit to change the lighting directions of the spotlights to the transmission direction determined by the direction determining unit.

In the configuration disclosed in JP-A-H07(1995)-312296, it is necessary to determine the transmission direction of the wireless signal based on the wireless signal received in the receiving unit. A circuit and the like for determining the transmission direction of the wireless signal and calculating lighting directions based on the determination result is required, resulting in a problem that the circuit configuration is complicated and it is not possible to accurately change the directions.

### SUMMARY OF THE INVENTION

One of objects of the present invention is to provide a device control system capable of controlling a part of one device or controllable parts of a plurality of devices by a simple configuration and a simple command.

According to an illustrative embodiment of the present invention, there is provided a device control system including: a plurality of devices each of which having at least one controllable part; and a controller including a processor and a memory storing computer-readable instructions that, when executed by the processor, causing the controller to perform: calculating positions, in which the plurality of devices are in a desired state, based on positional coordinates, at which the plurality of devices are installed, based on a one spatial coordinate; and generating a control signal for controlling the controllable part based on the calculated target positions, wherein the plurality of devices transitions the controllable part to the desired state according to the control signal.

According to another illustrative embodiment of the present invention, there is provided a device control system including: a device having at least one controllable part; and a controller including a processor and a memory storing computer-readable instructions that, when executed by the processor, causing the controller to perform: calculating a position, in which the device is in a desired state, based on positional coordinate, at which the device is installed, based on a one spatial coordinate; and generating a control signal for controlling the controllable part based on the calculated position, wherein the device transitions the controllable part to the desired state according to the control signal.

### BRIEF DESCRIPTION OF THE DRAWINGS

In the accompanying drawings:

FIG. 1 is a perspective view illustrating a device control system according to an embodiment of the present invention;

FIG. 2 is a block diagram illustrating each configuration of a remote controller and a moving light which are included in the device control system;

FIG. 3 is a diagram illustrating a display example of a touch panel of the remote controller in the present embodiment;

FIG. 4 is a diagram illustrating a method for calculating lighting positions of the moving lights from arrangement positions of the moving lights with respect to designated spatial coordinates of the device control system in the present embodiment;

FIGS. 5A and 5B are flowcharts illustrating an example of a control command operation of the device control system in the present embodiment; and

FIG. 6 is a diagram illustrating a calculation method of lighting positions of moving lights with respect to designated spatial coordinates as a modification example of the device control system in the present embodiment.

### DETAILED DESCRIPTION

Hereinafter, an embodiment of the present invention will be described in detail with reference to each of drawings.

The present embodiment is an example applied to a plurality of spotlights in which the state of illumination is changed according to usage or performance contents on a stage in a theater.

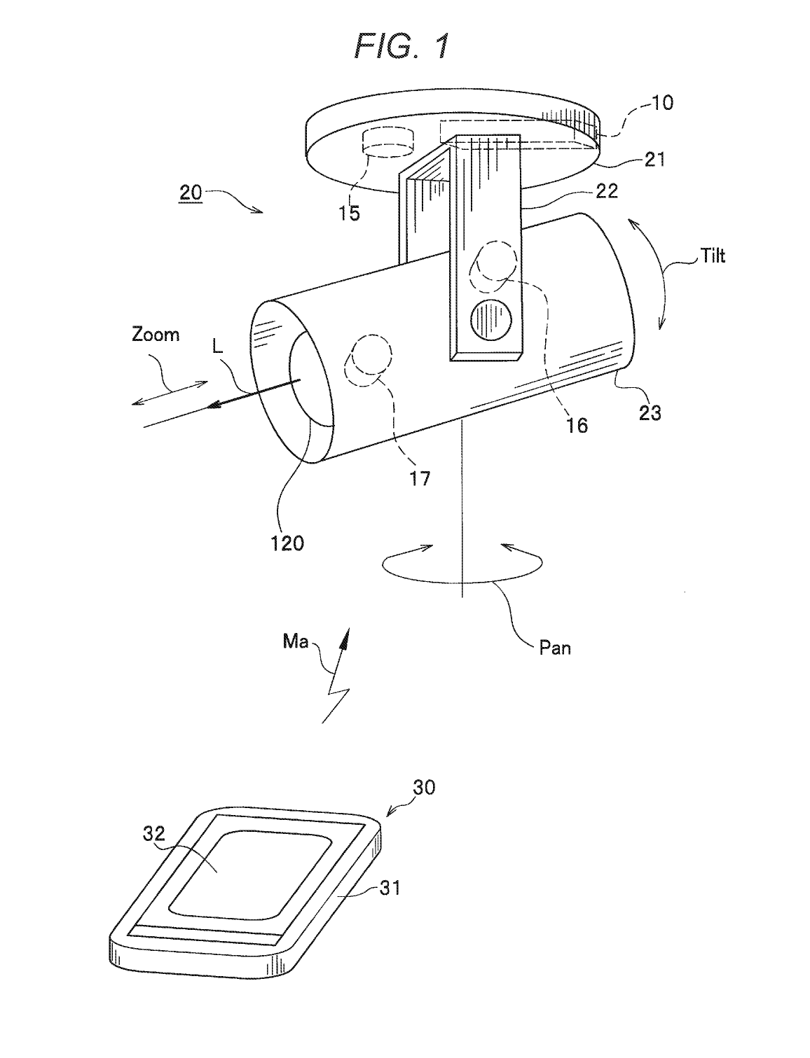

FIG. 1 is a perspective view illustrating a device control system 100 in the present embodiment.

As illustrated in FIG. 1, the device control system 100 includes a plurality of moving lights 20 (an example of a device; FIG. 1 illustrates only one) capable of controlling a lighting equipment 120 (an example of a part), and a remote controller 30 that transmits a control signal for indicating control of the lighting equipments 120 of the moving lights 20. Each moving light 20 includes a horizontal rotating unit 21, an arm 22 fixed to a lower side of the horizontal rotating unit 21, and a hood 23 held by the arm 22. The remote controller 30, for example, is a smart phone and is provided on an upper surface of a casing 31 thereof with a touch panel 32.

In each moving light 20, the horizontal rotating unit 21 includes a pan motor 15 and a variable controller 10. The horizontal rotating unit 21 is connected to a fixing part of a ceiling and is configured to be horizontally rotatable by the pan motor 15. The horizontal rotating unit 21 holds the arm 22 and can horizontally pan the illumination direction of the lighting equipment 120 by the rotation of the pan motor 15.

The hood 23 is held by the arm 22 and is configured to be vertically rotatable by a tilt motor 16 mounted to the arm 22. By the rotation of the tilt motor 16, the illumination direction of the lighting equipment 120 can be vertically tilted.

The hood 23 stores the lighting equipment 120 therein and is configured to be able to adjust a focal length of the lighting equipment 120 by a focus motor 17 and a lens (not illustrated).

The present embodiment describes an example of adjusting (controlling) the state of panning, tilting, zooming and the like of the moving light 20, but the present invention is not limited thereto and the state of any one of the panning, the tilting, and the zooming may be adjusted (controlled). Furthermore, the device is not limited to the moving light and may include a device for adjusting (controlling) the state of the panning, the tilting, the zooming and the like as a monitoring camera, a broadcasting camera and the like. Furthermore, the device may include a device for adjusting (controlling) the state of focus of a screen, a projection angle and the like by a motor by employing a projector, which is representatively referred to as a liquid crystal projector, a DLP projector (registered trademark) and the like, as a control target part. Moreover, the device may include a device for horizontally adjusting a direction, in which a television is directed, when the television is a part, a device for vertically and horizontally adjusting the wind direction of an air conditioner or an electric fan, and a device for adjusting a vertical position, a horizontal position, or an angle of an electric window, an electric blind, or an electric curtain.

Between the moving light 20 and the remote controller 30 of the present embodiment, bidirectional communication is performed. This communication method, for example, includes an RF (Radio Frequency) communication method representatively referred to as ZigBee (registered trademark), WiFi (registered trademark), Bluetooth (registered trademark) and the like. The communication method is a detailed example and is not limited thereto. Furthermore, a wired communication type, a wireless communication type and the like are available.

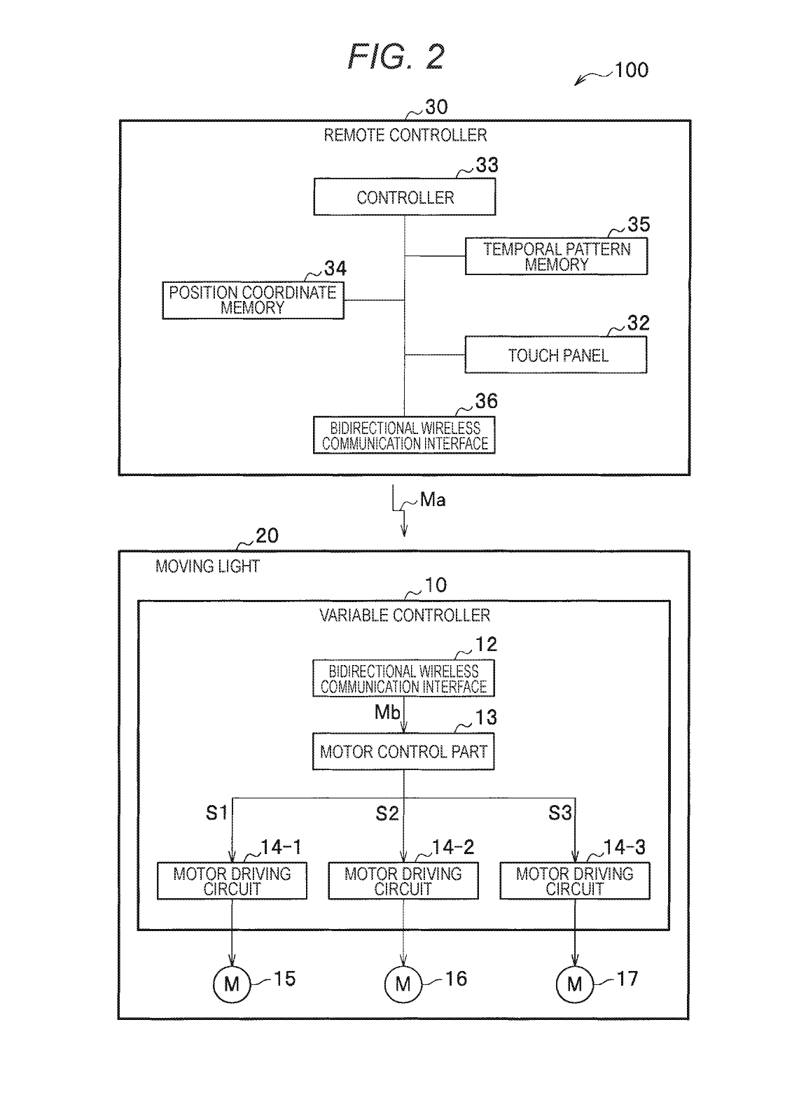

FIG. 2 is a block diagram illustrating each configuration of the remote controller 30 and the moving light 20 constituting the device control system 100.

The remote controller 30 includes a touch panel 32, a position coordinate memory 34, a temporal pattern memory 35, a bidirectional wireless communication interface 36 (a transmitter), and a controller 33 (a control unit) that controls these elements.

The controller 33 (an example of a control unit) controls each element of the remote controller 30, and for example, is embodied when a processor, CPU (Central Processing Unit), executes a control program.

<Basic Control>

The controller 33 calculates the lighting positions (an example of a target position) of the moving lights 20 based on positional coordinates, at which the moving lights 20 have been installed, based on a one spatial coordinate, and generates a control signal. That is, the controller 33 decides one lighting position, thereby reading the positional coordinates, at which the moving lights 20 have been installed, from the position coordinate memory 34, calculating the lighting positions of the moving lights 20 based on the read positional coordinates, and simultaneously operating the moving lights 20. The moving lights 20 operate in a coordinated manner according to the control signal from the remote controller 30, and allow the lighting equipments 120 of the moving lights 20 to be in a desired state. In this way, the moving lights 20 operate such that the respective lighting equipments 120 are directed to the one spatial coordinate.

<Pattern Control>

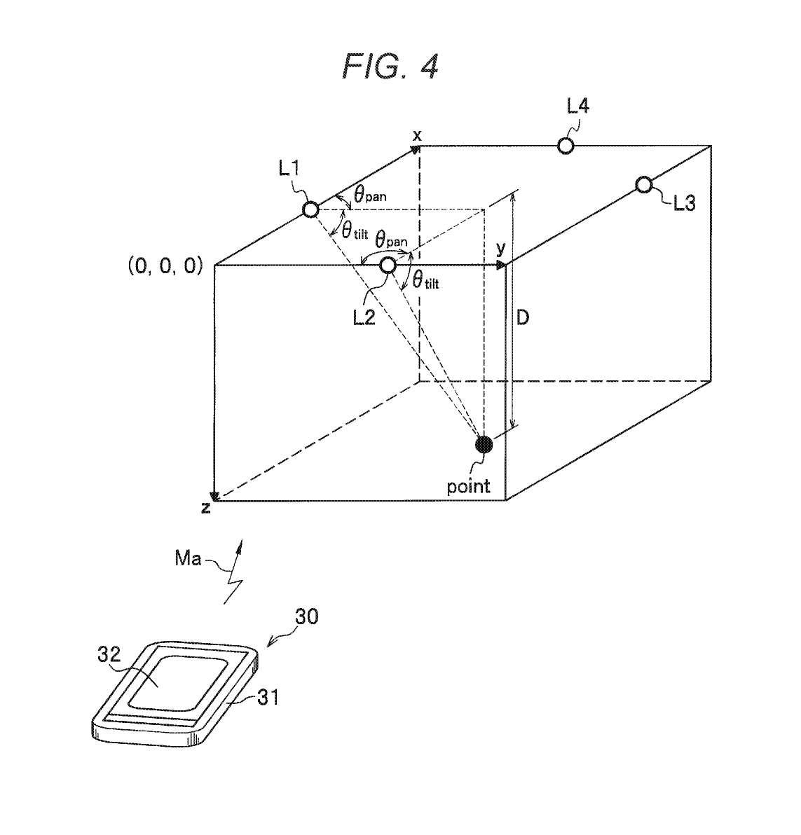

The controller 33 reads a temporal pattern from the temporal pattern memory 35, and operates each moving light 20 according to patterns set in advance based on the read temporal pattern. For example, the controller 33 allows moving lights L1 to L4 (see FIG. 4) to sequentially irradiate light in this order at every predetermined time, or allows the moving lights L2 and L4 to repeatedly irradiate light after the moving lights L1 and L3.

Furthermore, for example, when lighting points point exist in (four) corners of a rectangular carpet, the controller 33 operates the lighting equipments 120 of the moving lights 20 according to the patterns set in advance with respect to the corners of the carpet.

As described above, the lighting of each moving light 20 is adjusted with temporal patterns and lighting patterns set in advance.

<Lighting State Control>

The controller 33 transmits a control signal to the moving lights 20 and controls the lighting equipments 120 of the moving lights 20 to be in a desired lighting state. In this way, the moving lights 20 operate in a coordinated manner according to the control signal from the remote controller 30, and operate such that the lighting equipments 120 of the moving lights 20 are in the desired lighting state. The aforementioned lighting state, for example, is as follows. Depending on the installation positions of the moving lights 20, the controller 33 automatically adjusts “illuminance” to be bright when it is far and to be dark when it is near. Furthermore, depending on the installation positions of the moving lights 20, the controller 33 automatically adjusts “chromaticity”. In this case, colors of the moving lights 20 may overlap one another or not.

The touch panel 32 has a function as an user interface that performs an operation for deciding one spatial coordinate of the lighting points point by a touch operation. The touch panel 32, for example, is an electronic part in which position input devices are stacked on a liquid crystal panel and enables operation input when display on a screen is pressed.

The position coordinate memory 34 stores position coordinates at which the moving lights 20 have been installed.

The temporal pattern memory 35 stores temporal patterns for operating the lighting equipments 120 of the moving lights 20 according to patterns set in advance.

The moving light 20 includes the pan motor 15, the tilt motor 16, the focus motor 17, and the variable controller 10 that controls these motors. The variable controller 10 includes a bidirectional wireless communication interface 12 that receives a communication signal Ma (an example of a control signal) outputted from the remote controller 30, a motor control part 13 that controls the motors, and motor driving circuits 14-1 to 14-3. The variable controller 10 variably controls rotation speeds of the pan motor 15, the tilt motor 16, and the focus motor 17, respectively. Hereinafter, when the pan motor 15, the tilt motor 16, and the focus motor 17 are not particularly distinguished from one another, they are simply referred to as motors 15 to 17.

The bidirectional wireless communication interface 12 (an example of a transmitter) receives the communication signal Ma outputted from the remote controller 30, decodes the communication signal Ma, and outputs a reception signal Mb. The bidirectional wireless communication interface 12 extracts an ON signal or an OFF signal, directional information (panning, tilting, and zooming), and rotation directions of the motors from the communication signal Ma, and outputs these signals to the motor control part 13. When an indication of the communication signal Ma has been performed, the bidirectional wireless communication interface 12 transmits an OK signal to the remote controller 30.

Based on the reception signal Mb, the motor control part 13 generates indication signals S1 to S3 for controlling a rotation speed of any one of the motors 15 to 17. Hereinafter, when the indication signals S1 to S3 are not particularly distinguished from one another, they are simply referred to as an indication signal S. The indication signal S outputted from the motor control part 13 to the motor driving circuit 14 includes an indication of the rotation directions of the motors. For example, when the indication signal S is minus, the rotation direction of the motor is reversed.

The motor driving circuit 14-1 drives the pan motor 15 at a rotation speed corresponding to the indication signal S1. The pan motor 15 horizontally adjusts the illumination direction of the lighting equipment 120.

The motor driving circuit 14-2 drives the tilt motor 16 at a rotation speed corresponding to the indication signal S2. The tilt motor 16 vertically adjusts the illumination direction of the lighting equipment 120.

The motor driving circuit 14-3 drives the focus motor 17 at a rotation speed corresponding to the indication signal S3. The focus motor 17 adjusts the focal length of the lighting equipment 120 back and forth.

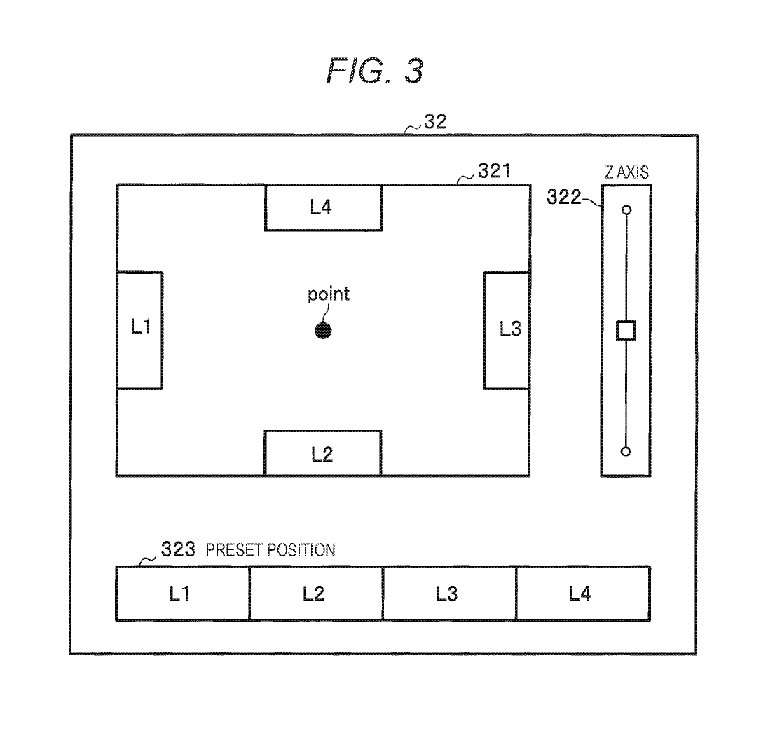

FIG. 3 is a diagram illustrating a display example of the touch panel 32 of the remote controller 30.

As illustrated in FIG. 3, on the touch panel 32 of the remote controller 30, a setting screen of a device position coordinate is displayed by predetermined mode switching. In the example of FIG. 3, the moving lights L1 to L4 (devices) to be described later are arranged in a rectangular frame 321 on an XY axis (on a horizontal plane). Furthermore, a lighting point “point” is also displayed. At the right side of the frame 321 on the XY axis (on the horizontal plane), the position of a Z axis for the XY axis is designated by a bar 322. The bar 322 on the touch panel 32 is dragged, so that the lighting point can be changed to an arbitrary depth. Such a layout can be arbitrarily set.

On the setting screen of the device position coordinate of the touch panel 32, the preset positions of the moving lights L1 to L4 (devices) are set and numerical values are displayed together with device names (for example, the moving light L1 (xxxx, yyyy)).

Spatial coordinates of the moving lights L1 to L4 set on the touch panel 32 are stored in the position coordinate memory 34. Herein, the preset position 323 of the moving lights L1 to L4 and the position bar 322 of the Z axis are stored in the position coordinate memory 34 as the spatial coordinates of the moving lights L1 to L4.

FIG. 4 is a diagram illustrating a method in which lighting positions of moving lights are calculated from arrangement positions of the moving lights for designated spatial coordinates.

As illustrated in FIG. 4, a three-dimensional lattice indicated by an XYZ axis, in which the origin (0, 0, 0) is employed as a base point, is assumed. The space surrounded by the lattice indicates the lighting range of the moving lights.

In the example of FIG. 4, the moving lights L1 to L4 are arranged on the lattice (on the horizontal plane) of the XY axis wherein the Z axis is 0. When viewed from the remote controller 30, the moving light L2 is arranged at a ceiling position nearest to the remote controller 30, the moving light L1 is arranged at a rear left side of the moving light L2, and the moving light L3 is arranged at a rear right side of the moving light L2. Furthermore, the moving light L4 is arranged at a ceiling position farthest from the remote controller 30. Symbols xₚₒₛᵢₜᵢₒₙ and yₚₒₛᵢₜᵢₒₙ to be described later indicate positions in a horizontal direction (on the XY axis) in which the moving lights L1 to L4 have been installed. The arrangement of the moving lights L1 to L4 is an example. The installation number of the moving lights is also arbitrary.

The remote controller 30 indicates one spatial coordinate to which each of the moving lights L1 to L4 irradiates light. Symbols xₚₒᵢₙₜ, yₚₒᵢₙₜ, and zₚₒᵢₙₜ to be described later are spatial coordinates of the lighting point “point” indicated by the remote controller 30. In the example of FIG. 4, the moving lights L1 to L4 irradiate light downward from above toward the lighting point “point” (for example, a floor or a display case on the floor). That is, the lighting point “point” is irradiated by the moving light L1 from the upper left side, is irradiated by the moving light L2 from the upper front side, is irradiated by the moving light L3 from the upper right side, and is irradiated by the moving light L4 from the upper rear side. The indication of the lighting point “point” is an example. The number of the lighting points point is also arbitrary.

A description will be provided for a calculation example in which the position (xₚₒᵢₙₜ, yₚₒᵢₙₜ, and zₚₒᵢₙₜ) of the lighting point “point” is indicated by employing the moving lights L1 and L2 of the moving lights L1 to L4 as an example.

Depending on positions in which the moving lights L1 and L2 are arranged in a lattice indicating a lighting range, rotating angle calculation in the horizontal direction differs.

There are a case where the moving lights are positioned on a lattice line parallel with the X axis (Y=0 or Y=maximum value) and a case where the moving lights are positioned on a lattice line parallel with the Y axis (X=0 or X=maximum value).

[Case Where Moving Lights Are Positioned on Lattice Line Parallel With Y Axis]

For the moving lights L2 and L4 positioned on the lattice line parallel with the Y axis (X=0 or X=maximum value), that is, xₚₒₛᵢₜᵢₒₙ=0 indicates the moving light L2 and xₚₒₛᵢₜᵢₒₙ=xₘₐₓ indicates the moving light L4.

The X axis position xₚₒₛᵢₜᵢₒₙ when the moving lights L2 and L4 are positioned on the Y axis is expressed by the condition of Equation (1) below.

xₚₒₛᵢₜᵢₒₙ=0 or xₚₒₛᵢₜᵢₒₙ=xₘₐₓ (1)

An offset angle θ_{offset}_{_}_{y}_{_}ₐₓᵢₛ of the Y axis used in the rotating angle calculation in the horizontal direction is calculated by Equation (2) below from arctangent (arctan) with an absolute value of the difference between the position xₚₒᵢₙₜ indicated on the x axis of the lighting point “point” and the spatial position xₚₒₛᵢₜᵢₒₙ on the X axis, in which the moving light L2 has been installed, and an absolute value of the difference between the position yₚₒᵢₙₜ indicated on the y axis of the lighting point “point” and the spatial position yₚₒₛᵢₜᵢₒₙ on the Y axis, in which the moving light L2 has been installed.

$${θ}_{offset\_y \_axis} = arctan \frac{\vert {x}_{point} - {x}_{position} \vert}{\vert {y}_{point} - {y}_{position} \vert} \qquad ( 2 )$$

Based on the offset angle θ_{offset}_{_}_{y}_{_}ₐₓᵢₛ of the Y axis calculated by Equation (2) above, a rotating angle θpan in the horizontal direction when the position of the moving light L2 is positioned on the lattice line parallel with the Y axis (herein, X=0) is calculated.

The rotating angle θpan calculated by arctan is within 90 degrees. When viewed from the upper side of (directly above) FIG. 4, if the arrangement position of the moving light L2 is in the origin (0, 0) of the XY axis, there are a case (case 1) where θpan is exists the first quadrant by turning around clockwise from θ=0 degrees (2π−θ_{offset}_{_}_{y}_{_}ₐₓᵢₛ), a case (case 2) where θpan exists in the fourth quadrant by turning around clockwise from θ=0 degrees (π+θ_{offset}_{_}_{y}_{_}ₐₓᵢₛ), and a case (case 3) where θpan exists in a position in which the X axis is perpendicular to the Y axis. In the positional relation among the case 1 to the case 3, the second quadrant and the third quadrant are excluded.

In the aforementioned case 1, the rotating angle θpan in the horizontal direction is calculated by Equation (3) below.

θₚₐₙ=2π−θ_{offset}_{_}_{y}_{_}ₐₓᵢₛ(yₚₒᵢₙₜ<yₚₒₛᵢₜᵢₒₙ) (3)

In the aforementioned case 2, the rotating angle θpan in the horizontal direction is calculated by Equation (4) below.

θₚₐₙ=π+θ_{offset}_{_}_{y}_{_}ₐₓᵢₛ(yₚₒᵢₙₜ>yₚₒₛᵢₜᵢₒₙ) (4)

In the aforementioned case 3, the rotating angle θpan in the horizontal direction is calculated by Equation (5) below.

θₚₐₙ= 3/2π(yₚₒᵢₙₜ=yₚₒₛᵢₜᵢₒₙ) (5)

Thus, when the moving lights L2 and L4 are positioned on the lattice line parallel with the Y axis (X=0 or X=maximum value), the X axis position xₚₒᵢₙₜ and the rotating angle θpan in the horizontal direction are calculated. In the same manner, when the moving lights L2 and L4 are positioned on the lattice line parallel with the X axis (Y=0 or Y=maximum value), the Y axis position yₚₒᵢₙₜ and the rotating angle θpan in the horizontal direction can be calculated.

[Case Where Moving Lights Are Positioned on Lattice Line Parallel With X Axis]

For the moving lights L1 and L3 positioned on the lattice line parallel with the X axis (Y=0 or Y=maximum value), that is, yₚₒₛᵢₜᵢₒₙ=0 indicates the moving light L1 and yₚₒₛᵢₜᵢₒₙ=yₘₐₓ indicates the moving light L3.

The Y axis position yₚₒₛᵢₜᵢₒₙ when the moving lights L1 and L3 are positioned on the X axis is expressed by the condition of Equation (6) below.

yₚₒₛᵢₜᵢₒₙ=0 or yₚₒₛᵢₜᵢₒₙ=yₘₐₓ (6)

An offset angle θ_{offset}_{_}ₓ_{_}ₐₓᵢₛ of the X axis used in the rotating angle calculation in the horizontal direction is calculated by Equation 7 below from arctangent (arctan) with an absolute value of the difference between the position yₚₒᵢₙₜ indicated on the y axis of the lighting point “point” and the spatial position yₚₒₛᵢₜᵢₒₙ on the Y axis, in which the moving light L1 has been installed, and an absolute value of the difference between the position xₚₒᵢₙₜ indicated on the x axis of the lighting point “point” and the spatial position xₚₒₛᵢₜᵢₒₙ on the X axis, in which the moving light L1 has been installed.

$${θ}_{offset\_x \_axis} = arctan \frac{\vert {y}_{point} - {y}_{position} \vert}{\vert {x}_{point} - {x}_{position} \vert} \qquad ( 7 )$$

Based on the offset angle θ_{offset}_{_}ₓ_{_}ₐₓᵢₛ of the X axis calculated by Equation 7 above, a rotating angle θpan in the horizontal direction when the position of the moving light L1 is positioned on the lattice line parallel with the X axis (herein, Y=0) is calculated.

When viewed from the upper side of (directly above) FIG. 4, if the arrangement position of the moving light L1 is in the origin (0, 0) of the XY axis, there are a case (case 1) where θpan exists in the first quadrant by turning around clockwise from θ=0 degrees (2π−θ_{offset}_{_}ₓ_{_}ₐₓᵢₛ), a case (case 2) where θpan exists in the fourth quadrant by turning around clockwise from θ=0 degrees (π+θ_{offset}_{_}ₓ_{_}ₐₓᵢₛ), and a case (case 3) where θpan exists in a position in which the Y axis is perpendicular to the X axis. In the positional relation among the case 1 to the case 3, the second quadrant and the third quadrant are excluded.

In the aforementioned case 1, the rotating angle θpan in the horizontal direction is calculated by Equation (8) below.

θₚₐₙ=2π−θ_{offset}_{_}ₓ_{_}ₐₓᵢₛ(xₚₒᵢₙₜ<xₚₒₛᵢₜᵢₒₙ) (8)

In the aforementioned case 2, the rotating angle θpan in the horizontal direction is calculated by Equation (9) below.

θₚₐₙ=π+θ_{offset}_{_}ₓ_{_}ₐₓᵢₛ(xₚₒᵢₙₜ>xₚₒₛᵢₜᵢₒₙ) (9)

In the aforementioned case 3, the rotating angle θpan in the horizontal direction is calculated by Equation (10) below.

θₚₐₙ= 3/2π(xₚₒᵢₙₜ=xₚₒₛᵢₜᵢₒₙ) (10)

Thus, when the moving lights L1 and L3 are positioned on the lattice line parallel with the X axis (Y=0 or Y=maximum value), the Y axis position Yₚₒᵢₙₜ and the rotating angle Θpan in the horizontal direction can be calculated.

Next, an angle θtilt and a distance D in the vertical direction will be described.

[Angle θtilt and Distance D in Vertical direction]

The angle θtilt in the vertical direction is calculated by Equation (11) below from a direct distance between the moving light and a target point on the XY plane and a distance in the Z axis direction.

$${θ}_{tilt} = arctan \frac{\sqrt{{( {x}_{point} - {x}_{position} )}^{2} + {( {y}_{point} - {y}_{position} )}^{2}}}{z} \qquad ( 11 )$$

The distance D in the vertical direction is calculated by Equation (12) below from the direct distance between the moving light and the target point on the XY plane and the distance in the Z axis direction.

D=\sqrt{(xₚₒᵢₙₜ−xₚₒₛᵢₜᵢₒₙ)²+(yₚₒᵢₙₜ−yₚₒₛᵢₜᵢₒₙ)²+z²} (12)

So far, the calculation method of the pan and the tilt has been described. Also for the zoom, it is possible to decide a focus according to a distance up to a coordinate indicated from the moving lights L1 to L4. Setting with out of focus is also possible. When a lens is configured to be mounted at a lighting side of the lighting equipment 120 of the moving light 20, it is possible to more appropriately adjust the focus of zoom.

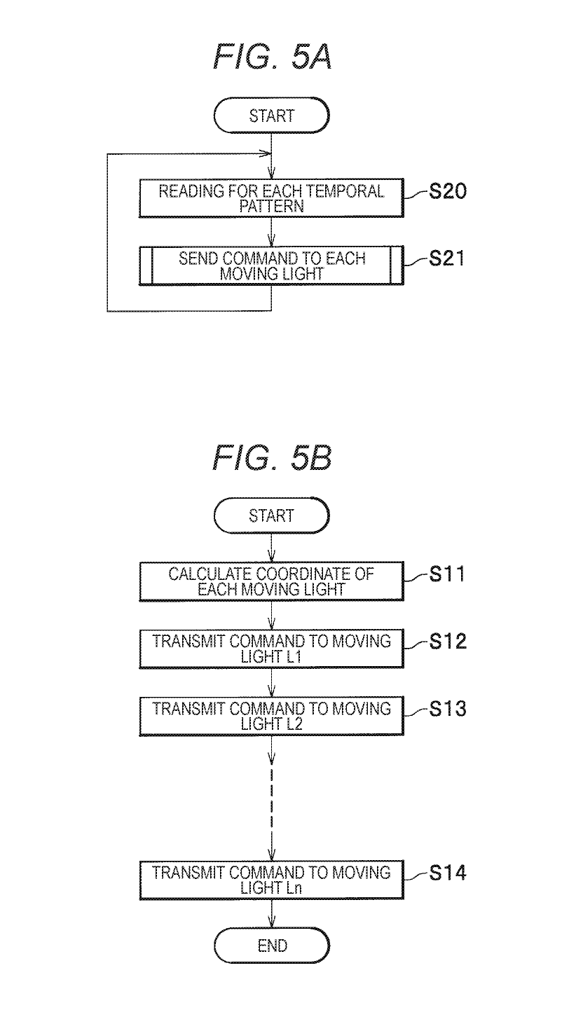

FIGS. 5A and 5B are flowcharts illustrating an example of a control command operation.

FIG. 5A is a flowchart illustrating a control command operation using a temporal pattern.

In the device control system 100, an operator indicates one spatial coordinate with the remote controller 30 (see FIG. 2).

As illustrated in FIG. 4, the operator designates only one lighting point “point” in a space in which the moving lights L1 to L4 have been arranged.

The controller 33 (see FIG. 2) of the remote controller 30 reads lighting timing information of each of the moving lights L1 to Ln from the temporal pattern memory 35 (step S20).

The controller 33 sends a control command to each of the moving lights L1 to Ln (step S21).

FIG. 5B is a flowchart illustrating a control command operation for each moving light.

The controller 33 calculates positions, in which the moving lights L1 to Ln irradiate light to the lighting point “point”, based on positional coordinates at which the moving lights L1 to Ln have been arranged (step S11). In the example of FIG. 4, based on the positional coordinates of the moving lights L1 to L4, the lighting positions of the moving lights L1 to L4 are calculated according to the aforementioned Equations 1 to 12. Specifically, the controller 33 calculates the rotating angle θpan in the horizontal direction and the angle θtilt in the vertical direction of the moving light L1 based on the arrangement position of the moving light L1, and calculates the distance D in the Z axis direction based on the direct distance between the moving light L1 and the target point on the XY plane. In the present embodiment, the controller 33 collectively calculates the coordinates (control contents) of the moving lights L1 to Ln in advance.

The controller 33 sequentially transmits control commands based on the calculated coordinates (the control contents) of the moving lights L1 to Ln to the moving lights L1 to Ln. That is, the controller 33 transmits the control command based on the calculated coordinate to the moving light L1 (step S12), transmits the control command based on the calculated coordinate to the moving light L2 (step S13), and then transmits the control command based on the calculated coordinate to the moving light Ln (step S14) in the same manner, thereby ending the flow of (b) of FIG. 5.

The flows of FIGS. 5A and 5B illustrate the procedures in which all the coordinates (control contents) of a plurality of moving lights L1 to Ln are collectively calculated in advance and then commands are sequentially transmitted to the moving lights. However, the coordinate calculation needs not to be collectively performed, and calculating the coordinate for each of the moving lights L1 to Ln and sending the control command may be repeated.

Furthermore, the command is not limited to the method for directly sending the command to each of a plurality of moving lights L1 to Ln. For example, the controller 33 and the bidirectional wireless communication interface 36 may perform mesh-like propagation by a communication method using a mesh network. That is, the controller 33 may simultaneously transmit a control command to all the moving lights L1 to Ln, the command may be first transmitted to a moving light nearest to the remote controller 30, and then the command may be sequentially transmitted to a moving light which is second nearest to the remote controller 30 (propagated in a mesh-like manner).

As described above, the device control system 100 includes the plurality of moving lights 20 capable of controlling the lighting equipments 120 and the remote controller 30 that transmits a control signal for indicating control of the lighting equipments 120 of the moving lights 20. The remote controller 30 includes the touch panel 32, which is an user interface that performs an operation for deciding one spatial coordinate, the controller 33, which calculates the lighting positions of the moving lights 20 based on the positional coordinates of the moving lights 20 based on the one spatial coordinate and generates a control signal, and the bidirectional wireless communication interface 36 which transmits the control signal to the moving lights 20. The moving lights 20 operate in a coordinated manner according to the control signal from the remote controller 30, and allow the respective lighting equipments 120 to be in a desired state.

When a device is the moving light 20, one lighting position is decided, so that the lighting positions of the moving lights 20 can be calculated based on the positional coordinates at which the moving lights 20 have been installed and the moving lights can operate in a coordinated manner with respect to one command.

With this configuration, an operator can indicate one spatial coordinate by the remote controller 30, thereby controlling the plurality of moving lights 20 to cooperate with one another and thus the respective lighting equipments 120 (an example of parts) to be in a desired state. Specifically, the following advantages can be obtained.

(1) One command (one spatial coordinate) is sent to the moving lights 20, so that the moving lights 20 can simultaneously operate.

(2) In the present embodiment, the position coordinate memory 34 is provided to store the positional coordinates of the moving lights 20 in advance, and the controller 33 calculates the lighting positions of the moving lights 20 based on the positional coordinates stored in advance. By simply storing the positional coordinates of the moving lights 20 in advance, desired control is possible, so that a simple configuration can be realized and an inexpensive system can be realized.

(3) When the installation position of the moving light 20 has been changed, a new moving light 20 has been added, or an arbitrary moving light 20 has been removed, since the positional coordinate is simply updated, added, or deleted, flexible and easy change is possible.

(4) In the present embodiment, the temporal pattern memory 35 is provided to store temporal patterns for operating the lighting equipments 120 of the moving lights 20 according to patterns set in advance. Various patterns are stored in the temporal pattern memory 35, so that it is possible to make performance according to various situations.

(5) Furthermore, since various patterns are stored in the temporal pattern memory 35 in advance, corresponding setting work can be simultaneously performed in advance and it is advantageous in that setting is easy. Moreover, since the control is possible by simply reading the patterns stored in advance from the temporal pattern memory 35, it is possible to immediately perform the control.

(6) A communication method using a mesh network is employed, so that control in a remote device is possible.

(7) In the present embodiment, since the lighting equipments 120 of the moving lights 20 are allowed to operate in a coordinated manner, it is possible to more effectively perform the illumination of the lighting equipments 120 with respect to the lighting point “point” by the coordinated operation (for example, the moving lights 20 irradiate light to the lighting point “point” at the same time or at different times). That is, the moving lights 20 are allowed to operate in a coordinated manner with respect to a certain lighting point “point”, so that it is possible to realize an effective illumination state with sense of unity. However, the present invention is not limited to the coordinated operation of devices and individual device may independently operate. Furthermore, a part of a device may be allowed to operate in a coordinated manner and another device may be allowed to independently operate.

### Modification Example

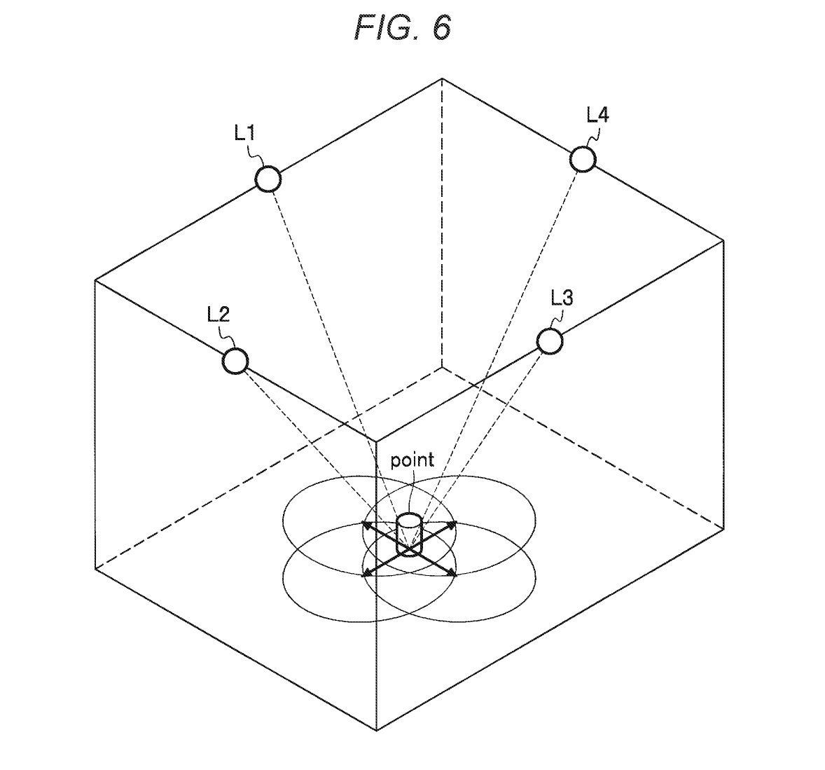

FIG. 6 is a diagram illustrating a calculation method of lighting positions of moving lights with respect to designated spatial coordinates as a modification example. The same reference numerals are used to designate the same elements as those of FIG. 4.

The controller 33 (see FIG. 2) calculates the lighting positions of the moving lights 20 based on positional coordinates, at which the moving lights 20 have been installed, based on a one spatial coordinate, and generates a control signal.

In the present modification example, based on the positional coordinates, at which the moving lights 20 have been installed, the controller 33 (see FIG. 2) generates a control signal in which a spatial coordinate obtained by shifting a one spatial coordinate by a predetermined distance is indicated as the lighting positions of the moving lights 20. In the example of FIG. 6, positions, in which the lighting positions of the moving lights L1 to L4 are changed from the original spatial coordinates (the heads of arrows of FIG. 6) to spatial coordinates (the start points of the arrows of FIG. 6) before a predetermined distance, are calculated, and a control signal is generated. The shift amount of the aforementioned spatial coordinate may be a predetermined value, or may be a value obtained by proportionally dividing distances from the moving lights L1 to L4 to the lighting point “point” and multiplying a coefficient.

In this way, the moving lights L1 to L4 respectively irradiate light toward a position (a slight rear position) shifted from the original spatial coordinate of the lighting point “point”, other than the center portion of the lighting point “point”. The moving lights L1 to L4 irradiate light to lighting spots indicated by oval areas shown in FIG. 6. The lighting spots (see the oval areas shown in FIG. 6) of the moving lights L1 to L4 partially overlap one another. In other words, the controller 33 (see FIG. 2) generates a control signal which indicates a spatial coordinate at which the lighting spots of the moving lights L1 to L4 partially overlap one another. The lighting point “point” exists in a position overlapping the lighting spots (see the oval areas shown in FIG. 6) of the moving lights L1 to L4.

In the present modification example, the lighting point “point” is lightened by the moving lights L1 to L4 from a position slightly shifted from the original spatial coordinate of the lighting point “point”. Therefore, the lighting point “point” is lightened at a deeper lighting angle from all directions, so that light can be irradiated in a wide range and rich display can be made in a shadow with depth.

### Other Modification Examples

The present invention is not limited to the aforementioned embodiments and various modifications can be made within the scope of the present invention; for example, there are the following (a) to (j).

(a) Although the present embodiment has described the example in which the remote controller 30 includes the controller 33 (an example of a control unit) having the present control program, the present control program may be introduced into any devices. That is, the remote controller may not be included in the device control system, and any device control systems may be employed if they have a function of executing the present control program.

(b) Although the present embodiment has described a control system that controls a plurality of devices, the number of the devices may be one. Even though there is one device, it is possible to obtain a unique effect that the device can be allowed to easily enter a desired state by simply indicating one positional coordinate.

(c) It is sufficient if a device has a part of which direction is changed, and the device is not particularly limited. For example, the device may include a monitoring camera, an indoor/outdoor speaker and the like in addition to a moving light. Furthermore, a part of the device may include a camera, a speaker and the like in addition to an lighting equipment.

(d) Although the present embodiment illustrated based on FIG. 4 has been described based on the assumption that a moving light irradiates light into a space surrounded by a lattice, the present invention is not limited thereto and the moving light may irradiate light out of the space.

(e) The calculation method of the lighting position of the moving light is not limited to Equations 1 to 12 above.

(f) In the specified example of FIG. 5B, the controller 33 collectively calculates the coordinates (control contents) of all the moving lights 20 in advance, and then sequentially transmits commands to the moving lights 20; however, the coordinate calculation needs not to be collectively performed and calculating the coordinate for each of the moving lights 20 and sending the command may be repeated. Furthermore, the generation timing of the control signal by the controller 33 is not particularly limited.

(g) The command is not limited to a method for directly sending the command to each of a plurality of moving lights, and commands may be simultaneously transmitted to all the moving lights 20 so as to be sequentially transmitted from the nearest moving light 20 to the second nearest moving light 20 (propagated in a mesh-like manner).

(h) The remote controller 30 is not limited to a dedicated remote controller, and may include a smart phone. Furthermore, the touch panel 32 is not also essential and a mechanical switch is available.

(i) In relation to a signal between the remote controller 30 and a control target device, a permission signal, a lock signal, an unlock signal, an OK signal and the like are not essential. Communication between the remote controller 30 and the control target device is not limited to bidirectional communication, and for example, a moving signal may be transmitted through one-way communication such as infrared communication and visible light communication.

(j) The operation of the touch panel 32 of the remote controller 30 is not particularly limited. For example, the lighting point “point” may be set by a tap, the setting of the lighting point “point” may be confirmed, and then a control signal may be generated by a double tap based on the positional coordinates of the moving lights 20.

According to the present invention, it is possible to control a part of one device or control parts of a plurality of devices in a coordinated manner by a simple configuration and a simple command.

What is claimed is:

1. A device control system comprising:
a plurality of devices each of which having at least one controllable part; and
a controller including a processor and a memory storing computer-readable instructions that, when executed by the processor, causing the controller to perform:
calculating target positions, in which the plurality of devices are in a desired state, based on positional coordinates, at which the plurality of devices are installed, based on a one spatial coordinate; and
generating a control signal for controlling the controllable part based on the calculated target positions,
wherein the plurality of devices transitions the controllable part to the desired state according to the control signal.

2. The device control system according to claim 1 further comprising:
a remote controller including:
the controller;
an user interface that receives input from an operator to determine the one spatial coordinate;
a transmitter that transmits the control signal generated by the controller.

3. The device control system according to claim 2,
wherein the transmitter transmits the control signal via a communication method using a mesh network in which a command is sequentially transmitted from a predetermined device to another device other than the predetermined device.

4. The device control system according to claim 2,
wherein the controller generates the control signal for controlling the controllable part of the devices to face toward the one spatial coordinate.

5. The device control system according to claim 2,
wherein the controller generates the control signal for controlling the controllable part of the devices to operate according to a preset pattern that is defined for the one spatial coordinate.

6. The device control system according to claim 2,
wherein each of the plurality of devices is a moving light and the controllable part is an lighting equipment,
wherein the moving lights transitions the lighting equipments to a desired illumination state according to the control signal generated by the controller of the remote controller.

7. The device control system according to claim 6,
wherein the controller generates the control signal to adjust illuminance according to installation positions of the plurality of moving lights.

8. The device control system according to claim 6,
wherein the controller generates the control signal to adjust chromaticity according to installation positions of the plurality of moving lights.

9. The device control system according to claim 6,
wherein the controller generates the control signal to adjust a direction of the moving lights in a preset temporal pattern.

10. A device control system comprising:
a device having at least one controllable part; and
a controller including a processor and a memory storing computer-readable instructions that, when executed by the processor, causing the controller to perform:
calculating a target position, in which the device is in a desired state, based on positional coordinate, at which the device is installed, based on a one spatial coordinate; and
generating a control signal for controlling the controllable part based on the calculated target position,
wherein the device transitions the controllable part to the desired state according to the control signal.
